(19) United States
(12) Patent Application Publication
(10) Pub. No.: US 2015/0205657 A1
(43) Pub. Date: Jul. 23, 2015

(54) PREDICTING FAILURE OF A STORAGE DEVICE

(71) Applicant: LONGSAND LIMITED, Cambridge (GB)

(72) Inventor: William R. Clark, Southborough, MA (US)

(21) Appl. No.: 14/418,669

(22) PCT Filed: Sep. 28, 2012
(86) PCT No.: PCT/US2012/057735

§ 371 Date: Jan. 30, 2015

(51) Int. Cl. G06F 11/07

(52) U.S. Cl. CPC G06F 11/0751; G06F 11/0727

(57) ABSTRACT

Techniques for predicting failure of a storage device are described in various implementations. An example method that implements the techniques may include receiving, at an analysis system and from a computing system having a storage device, current diagnostic information associated with the storage device. The method may also include storing, using the analysis system, the current diagnostic information in a collection that includes historical diagnostic information associated with other storage devices of other computing systems. The method may also include predicting, using the analysis system, whether the storage device is likely to fail in a given time period based on the current diagnostic information and an estimated lifespan for storage devices that are of a same classification as the storage device, the estimated lifespan determined based on the collection.

### BACKGROUND

Storage devices, such as hard disk drives used in computer systems, are complex devices with a number of electromechanical components. Over time or with a certain amount or type of usage, every storage device will eventually fail, which may result in the loss of data stored on the failed storage device. The loss of data from a failed storage device may have a significant economic and/or emotional impact on the affected users. For example, in the corporate context, the data that a company collects and uses is often one of the company's most important assets, and even a relatively small loss of data may prove to be costly for the company. In the personal computing context, a user may lose personal and/or financial records, family photographs, videos, or other important documents, some of which may be impossible to replace. As the amount of data that is stored by users continues to increase, so too does the potential for significant loss.

### BRIEF DESCRIPTION OF THE DRAWINGS

FIG. 1 shows a conceptual diagram of an example comp environment in accordance with an implementation described herein.

FIGS. 2A and 2B show examples of data tables that may be used in accordance with an implementation described herein.

FIG. 3 shows a block diagram of an example system in accordance with an implementation described herein.

FIG. 4 shows a flow diagram of an example process for predicting the failure of a storage device in accordance with an implementation described herein.

FIG. 5 shows a swim-lane diagram of an example process for collecting and interpreting scan results in accordance with an implementation described herein.

### DETAILED DESCRIPTION

The impact of hard drive or other storage device failure may be eliminated, or at least mitigated, through proactive data protection measures, including regular data backups or other data protection strategies. However, many computer users do not employ such proactive measures. Instead, users may back up their data irregularly, or may not back up their data at all—often waiting until there is some direct warning that the data is in jeopardy before considering a data backup solution. At that point, it may often be too late.

With such user behavior in mind, Self-Monitoring, Analysis and Reporting Technology (S.M.A.R.T.) was developed as a monitoring system for computer hard drives to self-identify various indicators of hard drive reliability, with the intended purpose of warning users of impending hard drive failures. A result of a S.M.A.R.T. scan may typically indicate one of two values: that the drive is “OK” or that it is “about to fail”, where failure in this context means that the drive will not continue to perform as specified (e.g., the drive will perform slower than the minimum specification, the drive will suffer a catastrophic failure, or somewhere in between).

S.M.A.R.T. warnings may provide a user with an opportunity to backup or otherwise protect their data, but many S.M.A.R.T.-enabled devices fail without providing any type of warning to the user. Furthermore, many drives that “fail” a S.M.A.R.T. scan may continue operating normally for a long period of time. As such, S.M.A.R.T. scans, on their own, may be a fairly unreliable indicator of whether a drive will actually fail soon, and if so, when the failure might be expected to occur. One of the reasons S.M.A.R.T. scan results alone may be of limited value in predicting future failures is that the S.M.A.R.T. statistics used to predict possible drive failure are typically provided by individual drive manufacturers based on experiments that are conducted in controlled environments using limited numbers of drives. Such data may provide a relatively poor indicator of how normal populations of drives will perform in real world environments.

In accordance with the techniques described herein, real world diagnostic information, such as S.M.A.R.T. scan data and other appropriate data, may be collected over time for a large drive population, and the collected real world diagnostic information may be analyzed to provide a relatively accurate estimate of how long a particular class of drive is likely to operate before failing (e.g., an estimated lifespan for drives in the particular class). Such information may then be used to predict whether a specific drive in the drive population is likely to fail in a given time period, e.g., based on how many hours the drive has been used, the environment in which the drive has been used, and/or other appropriate factors.

The failure prediction information may be used to alert the user an appropriate amount of time before the drive actually fails—e.g., not too far in the future, which may lead to user complacency, but with enough notice so that the user can adequately protect the data stored on the drive. In some cases, for example, the user may be warned that the drive is likely to fail within the next two weeks, and may be prompted to set up or modify the computer's backup settings, or to replace the drive. Such failure prediction information may also be used, for example, by a backup provider to ensure that the user's data may be restored in an efficient manner (e.g., by caching the user's backup data for faster restore, or by providing an option to create a replacement drive imaged with the user's data), since there is a high likelihood that the user will soon experience a failure scenario. These and other possible benefits and advantages will be apparent from the figures and from the description that follows.

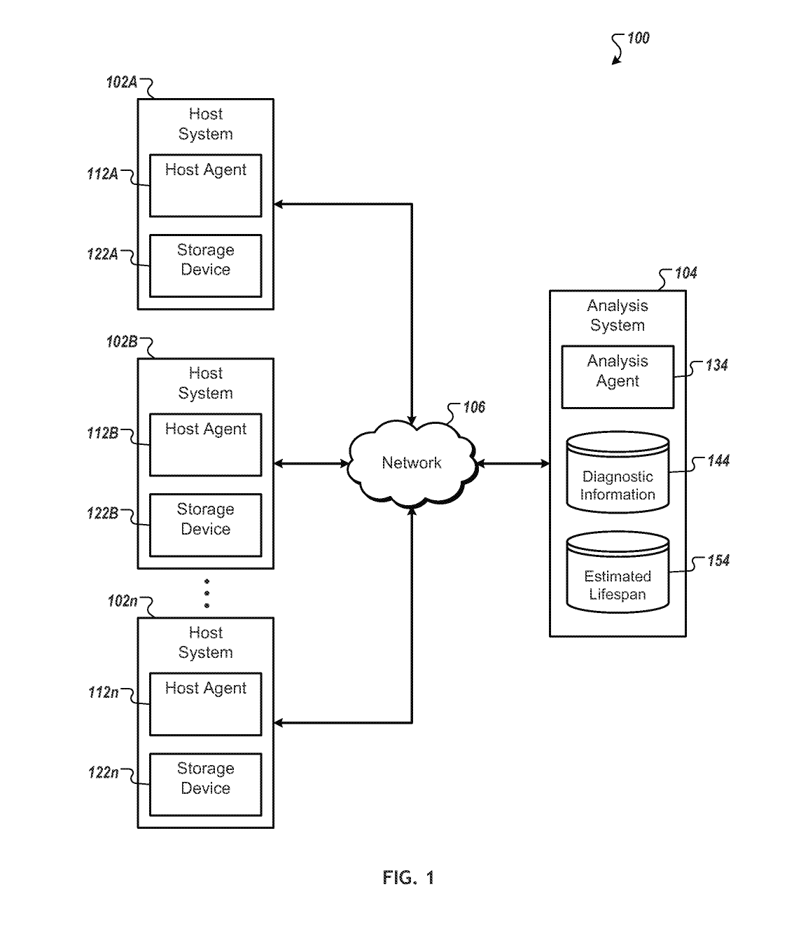

FIG. 1 shows a conceptual diagram of an example computing environment 100 in accordance with an implementation described herein. Environment 100 may include multiple host computing systems 102A, 102B, up through and including 102n. The host computing systems may represent any appropriate computing devices or systems including, for example, laptops, desktops, workstations, smartphones, tablets, servers, or the like. The host computing systems need not all be of the same type. Indeed, in many environments, the host computing systems 102A-102n will typically vary in type.

The host computing systems may be communicatively coupled to an analysis computing system 104, e.g., via network 106. Network 106 may take any appropriate form, including without limitation the Internet, an intranet, a local area network, a fibre channel network, or any other appropriate network or combination of networks. It should be understood that the example topology of environment 100 is shown for illustrative purposes only, and that various modifications may be made to the configuration. For example, environment 100 may include different or additional devices and/or components, and the devices and/or components may be connected in a different manner than is shown.

Host agents 112A, 112B, 112n may execute on each of the respective host computing systems 102A, 102B, 102n to collect diagnostic information associated with storage devices 122A, 122B, 122n, respectively. Although each host computing system is shown to include only a single storage device, it should be understood that certain systems in environment 100 may include multiple storage devices. The diagnostic information associated with each of the respective devices may include device reliability and/or failure information, including S.M.A.R.T. scan results and/or attributes. In some implementations, the host agent of a computing system having a storage device may be used to initiate a S.M.A.R.T. scan of the storage device on a periodic basis (e.g., once a week), on a scheduled basis (e.g., according to a user-defined schedule), or on an ad hoc basis (e.g., as requested by the user or the computing system). The S.M.A.R.T. scan may be initiated using available Windows Management Instrumentation (WMI) application programming interfaces (APIs), IOKit APIs, or other appropriate mechanisms. In addition to the specific scan results (e.g., “pass” or “fail”), the host agent may also retrieve one or more S.M.A.R.T. attributes, such as power-on hours, read error rate, reallocated sectors count, spin retry count, reallocation event count, temperature information, or the like. The raw values of these attributes may be indicative of the relative reliability (or unreliability) of the storage device as of the time of the scan. As the state of the particular storage device continues to evolve over time and with additional usage, the raw values of the S.M.A.R.T. attributes returned from scans performed at different times may also change.

The host agents 112A-112n may also collect certain diagnostic information associated with their respective host computing systems. Examples of diagnostic information collected from the host computing systems may include system configuration information (e.g., operating environment, system identification information, or the like), system events (e.g., disk failures, maintenance events, data restore requests, or the like), and/or other appropriate information. In some implementations, the diagnostic information associated with maintenance events may be used to identify the frequency and/or types of maintenance (e.g., check disk, defragmentation, etc.) performed on a particular storage device over time. In some implementations, the disk failure and/or data restore requests collected in the diagnostic information may be used to identify storage device failure events that may or may not have been identified from the S.M.A.R.T. scan results. Such information, combined with the most recent power-on hours attribute from a S.M.A.R.T. scan, may provide an actual lifespan of a failed storage device operated under real world conditions.

The host agents 112A-112n may transmit the gathered diagnostic information, including any failure information, to an analysis agent 134 executing on the analysis computing system 104. The analysis agent 134 may store the diagnostic information received, e.g., over time, from the various host computing systems in a repository 144. The diagnostic information maintained in repository 144 may include a number of different diagnostic parameters, as well as current and/or historical values associated with those parameters. In some cases, the diagnostic information may be organized into logical groupings or classifications including, for example, by device identifier (e.g., to group multiple diagnostics for a single device over time), by make and/or model (e.g., to group diagnostics from different devices that are of a same make and/or model), by device type (e.g., to group diagnostics from different devices that are of varying makes and/or models, but that are of a same general type), or by any other appropriate groupings.

In some implementations, the repository 144 may store only the most recent diagnostic information for each particular storage device, e.g., by updating a record associated with the particular storage device as new diagnostic information is received. For example, a particular host computing system may perform S.M.A.R.T. scans on a weekly basis, and only the most recent information may be stored in the repository 144. In other implementations, the repository 144 may store diagnostic information that is collected over time for each particular storage device, e.g., by adding the new diagnostic information associated with the particular storage device to a record, or by adding separate records as new diagnostic information is received. Continuing with the example of a system that performs S.M.A.R.T. scans on a weekly basis, the repository 144 may include the entire weekly history of scan results. In yet other implementations, the repository 144 may store a limited portion of the diagnostic information, e.g., the five most recent diagnostic results, associated with a particular storage device.

Over time, the repository 144 may be used to amass a collection of diagnostic information from a large population of storage devices in a large number of host computing systems operating under real world conditions. After the repository 144 includes sufficient information about a particular class of storage device (e.g., a particular make and model of device, a particular make and model operating in a particular system configuration, or a particular device type), the analysis agent 134 may determine an estimated lifespan for the particular class of storage device. The estimated lifespan for a particular class may be determined using all or certain portions of the diagnostic information, including the reliability and/or failure information, associated with the various storage devices in the class.

The particular technique for determining the estimated lifespan may be configurable, e.g., to be more conservative or less conservative, based on the particular goals of a given implementation. In some implementations, the estimated lifespan for a particular class of storage device may be determined using statistical analyses to fit the diagnostic information to a failure rate curve, and a configurable threshold failure level may be used to identify the estimated lifespan for the particular class of storage device. In some implementations, multiple failure rate curves and corresponding estimated lifespans may be identified for a particular class of device, based on how the device is maintained. For example, the failure rate curve for a device that is maintained regularly may be different from the failure rate curve for the same model of device in systems where the device is not maintained regularly. The estimated lifespans for various classifications of storage devices may be stored in a repository 154.

In use, when the analysis agent 134 receives current diagnostic information associated with a particular host computing system and storage device, the analysis agent 134 may store the diagnostic information in repository 144, and may also determine whether an estimated lifespan for the particular class of device is stored in the repository 154. If not, e.g., in cases where not enough data has been collected to generate an estimated lifespan that improves upon the S.M.A.R.T. results, then the analysis agent 134 may simply return the S.M.A.R.T. results to the host computing device. If an estimated lifespan for the particular class of device is stored in the repository 154, the analysis agent 134 may predict whether the storage device is likely to fail in a given time period based on the current diagnostic information and the estimated lifespan. For example, the analysis agent 134 may compare the power-on hours of the storage device to the estimated lifespan, with the difference indicating the amount of time remaining before a failure is likely to occur. As another example, in cases where different estimated lifespans are identified for a particular class, e.g., based on how the device is maintained, the analysis agent 134 may compare the power-on hours of the storage device to the estimated lifespan for storage devices that are maintained in a similar manner as the storage device to predict whether the storage device is likely to fail in the given time period.

When the analysis agent 134 determines that the storage device is likely to fail in a given time period, the agent may cause a notification to be displayed on the respective host computing system, e.g., indicating that the storage device is likely to fail within the given time period. For example, the host computing system with a storage device that is likely to fail in the next thirty hours may display a message, indicating to the user that the storage device will likely fail within the next thirty hours of use. The message may also identify recommended actions for the user to take. For example, the user may be prompted to back up the data on the storage device, to change their backup rules (e.g., to a more inclusive backup policy), to install backup software, to order a replacement drive, or the like.

The analysis agent 134 may also analyze the S.M.A.R.T. scan results to determine whether the S.M.A.R.T. attributes themselves indicate a potential impending failure. The analysis agent 134 may analyze various real world S.M.A.R.T. attributes that have been collected in repository 144 over time, including for drives that have failed, to gain an improved understanding of how drive failures are associated with those attributes. For example, while a drive manufacturer may report a failure threshold temperature of ninety-six degrees for a particular drive, the collected real world data from a large population of drives may show that the failure threshold temperature is actually ninety-five degrees. In such an example, if the current drive temperature of a drive is at or near the actual failure threshold temperature of ninety-five degrees, the analysis agent 134 may indicate an impending failure.

The analysis agent 134 may also analyze trends in the S.M.A.R.T. attributes to gain an improved understanding of how drive failures are associated with trends in those attributes. For example, the collection of real world data from a large population of drives may show that the drive temperature of a failing drive may trend upwards at a rate of approximately 0.02 degrees per hour of usage until the drive reaches the failure threshold temperature and fails. In such an example, if a current drive temperature of the drive is only ninety-three degrees, but has been increasing at a rate of approximately 0.02 degrees per hour of usage, the analysis agent 134 may determine that the drive is likely to reach the failure threshold temperature of ninety-five degrees in approximately one hundred hours of usage, and may indicate the failure timeline to the user.

If any such additional information may be gleaned from the S.M.A.R.T. attributes, the information may be combined with the estimated lifespan information in an appropriate manner (e.g., by reporting the shorter estimated failure timeline, or by reporting a confidence level that is higher if both results indicate similar failure timelines, or the like). The interpreted S.M.A.R.T. results may then be provided by the analysis agent 134 back to the host computing system. For example, the analysis agent 134 may analyze the various S.M.A.R.T. attributes that may actively contribute to a potential failure event, and may present a composite result back to the host computing system.

In some implementations, the analysis computing system 104 may be operated by, or on behalf of, a backup provider. The backup provider may use the interpreted S.M.A.R.T. scan results to provide additional functionality to its customers and/or potential customers. For example, certain of the host computing systems may be current customers of the backup provider, such that the backup provider has backup information associated with the customer. In such cases, when the interpreted scan results indicate an impending failure, the backup provider may take proactive measures to ensure that the customer's backed up data may be restored in an efficient manner (e.g., by caching the customer's data for faster restore, or by providing an option to create a replacement drive imaged with the customer's data, or the like). As another example, certain of the host computing systems may not be current customers of the backup provider. In such cases, when the interpreted scan results indicate an impending failure, the backup provider may use such information to offer a backup solution to the potential customer, e.g., by including the offer in the failure notification that is displayed on the host computing system. In either case, the backup provider may be able to provide users, whether they are customers or not, with customized attention at a time when the need for such attention is at its greatest—e.g., when there is still enough time to protect the data on a storage device that is about to fail—which may result in a significant benefit to the users.

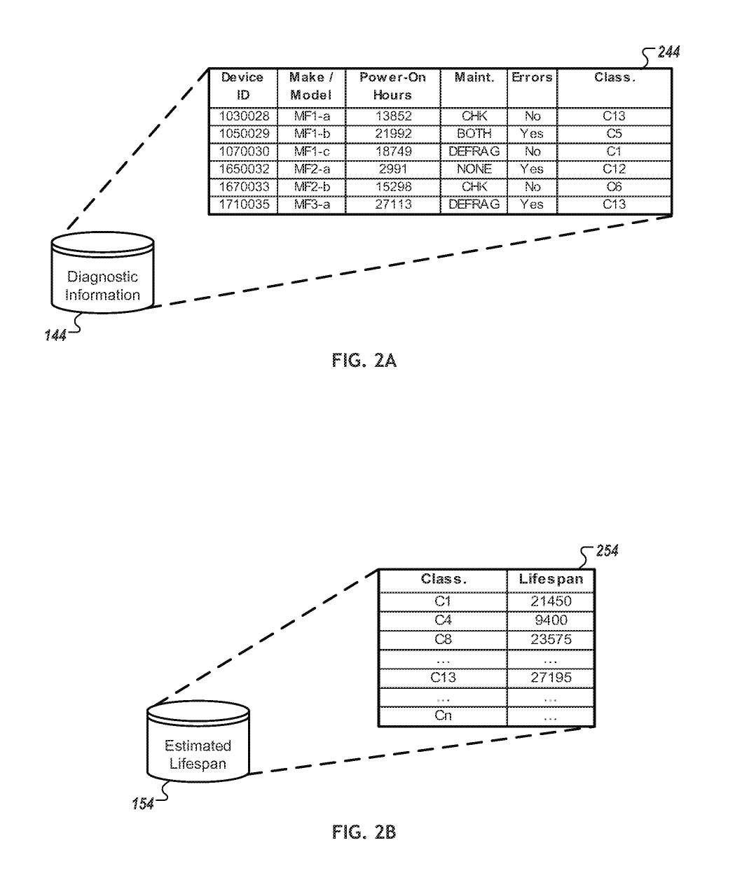

FIGS. 2A and 2B show examples of data tables 244 and 254 that may be used in an implementation described herein. As shown, table 244 may be stored in repository 144, and may include diagnostic information associated with a number of different storage devices. As shown, table 244 may include a unique device identifier, model information, power-on hours, maintenance information, error information, and classification information for each storage device in environment 100. For example, in the first row, a storage device having device identifier “1030028” is shown to be a model “a” device from manufacturer “MF1” that has been powered on for “13852” hours. The device has received regular check disk type of maintenance (but not regular defragmentation), and the most recent device scan did not identify any errors. Lastly the table 244 shows that the device has been classified as classification “C13”. In this instance, another device from a different manufacturer (“MF3”) is also classified as “C13”. In various implementations, certain classes may only include a specific make and model of device, or may include multiple models of a single make, or may include multiple makes and models. The table 244 may include a number of records grouped together into different classes, all of which may be considered when determining an appropriate lifespan estimate for devices in that class.

Table 254 may be stored in repository 154, and may include lifespan estimates for various classes of devices. The lifespan estimates may be determined, e.g., by analysis agent 134, based on the information stored in repository 144. As shown, table 254 includes lifespan estimates for at least classes “C1”, “C4”, “C8”, and “C13”, but some classes may not have an associated lifespan estimate, e.g., in cases where not enough diagnostic information about a particular class of storage device has been collected to provide an improved lifespan estimation. In some implementations, additional lifespan information may be included to account for different environmental or maintenance conditions. For example, if certain types of maintenance affect the estimated lifespan of a particular class of device by a non-negligible amount, the table may be modified to store such information. In some implementations, additional columns may be added, where the “lifespan” column may include normal lifespan estimates (e.g., assuming normal, but not regular maintenance), a “no maintenance lifespan” column may include lifespan estimates for devices in the particular classes where little or no maintenance has been performed, and other similar columns may be added for other appropriate levels and/or types of maintenance. In various implementations, the level of granularity that may be captured in table 254 may be configurable, e.g., to provide more or less granularity of specific lifespan estimation scenarios based on the various types of conditions or parameters that are being monitored.

As an example of the techniques described here, when the analysis agent 134 received the diagnostic information associated with Device ID “1710035”, which is classified as “C13”, the analysis agent 134 may have predicted that the storage device was likely to fail, e.g., within the next eighty-two hours based on the comparison of the estimated lifespan for class “C13” devices (“27195” hours) and the power-on hours (“27113” hours) that the device had already been used. As another example, when the analysis agent 134 received the diagnostic information associated with Device ID “1070030”, which is classified as “C1”, the analysis agent 134 may have not predicted an impending failure because the difference between the estimated lifespan for class “C1” devices (“21450” hours) and the power-on hours (“18749” hours) for the device indicates a sufficient buffer of remaining useful life before a failure condition is likely to occur.

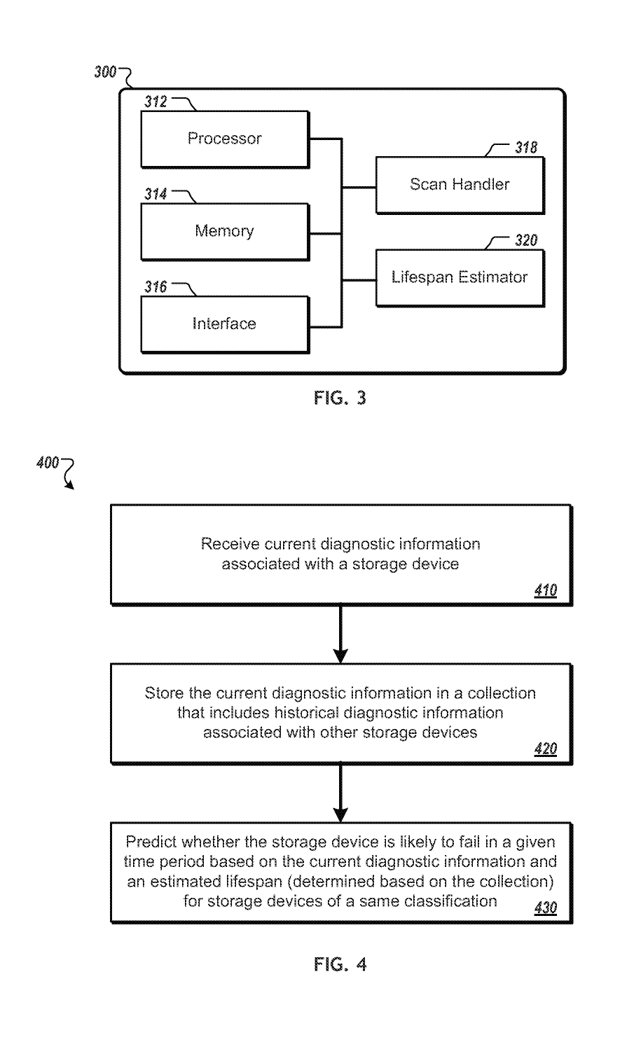

FIG. 3 shows a block diagram of an example system 300 in accordance with an implementation described herein. System 300 may, in some implementations, be used to perform portions or all of the functionality described above with respect to the analysis computing system 104 of FIG. 1. It should be understood that, in some implementations, one or more of the illustrated components may be implemented by one or more other systems. The components of system 300 need not all reside on the same computing device.

As shown, the example system 300 may include a processor 312, a memory 314, an interface 316, a scan handler 318, and a lifespan estimator 320. It should be understood that the components shown here are for illustrative purposes, and that in some cases, the functionality being described with respect to a particular component may be performed by one or more different or additional components. Similarly, it should be understood that portions or all of the functionality may be combined into fewer components than are shown.

Processor 312 may be configured to process instructions for execution by the system 300. The instructions may be stored on a non-transitory tangible computer-readable storage medium, such as in memory 314 or on a separate storage device (not shown), or on any other type of volatile or non-volatile memory that stores instructions to cause a programmable processor to perform the techniques described herein. Alternatively, or additionally, system 300 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

Interface 316 may be implemented in hardware and/or software, and may be configured, for example, to receive and respond to the diagnostic information provided by the various host computing systems in an environment. The diagnostic information may be received via interface 316, and interpreted results and/or notifications may be sent via interface 316, e.g., to the appropriate host computing systems. Interface 316 may also provide control mechanisms for adjusting certain configurations of the system 300, e.g., via a user interface including a monitor or other type of display, a mouse or other type of pointing device, a keyboard, or the like.

Scan handler 318 may execute on processor 312, and may be configured to receive, over time, diagnostic information from the various host computing systems in a particular environment, and store the diagnostic information in a repository (not shown). The diagnostic information may include, for example, reliability information and/or failure information. As the diagnostic information is received from the various host computing systems, the scan handler 318 may also predict whether the particular storage device is facing an impending failure.

For example, the scan handler 318 may compare a power-on attribute of the storage device to an estimated lifespan associated with a population of storage devices that are of a same classification, and may predict that a failure is likely to occur if the power-on hours attribute exceeds or is approaching the estimated lifespan. If so, then the scan handler 318 may generate a failure notification to be provided to the host computing system.

In some implementations, the threshold for whether a power-on hours attribute is approaching an estimated lifespan may be configurable, and may be defined, e.g., as a specific time period (e.g., eighty hours) or as a percentage of the estimated lifespan (e.g., 98% of the estimated lifespan). In other implementations, the threshold may be based on the frequency of device scans performed by the particular host computing system. For example, if a particular storage device is typically powered-on one hundred hours between scans, then the threshold may be set at a level that is a safe margin under one hundred hours such that a failure that is likely to occur before the next scan may be identified in time for a notification to be provided to the user.

As another example, the scan handler 318 may compare other S.M.A.R.T. attributes of the storage device, or trends of such attributes, to failure models that have been determined based on the collected real world data. For example, while a drive manufacturer may report a failure threshold temperature of ninety-six degrees for a particular drive, the collected real world data from a large population of drives may show that the failure threshold temperature is actually ninety-five degrees. As another example, the collected data may show that the drive temperature of a failing drive may trend upwards at a rate of approximately 0.02 degrees per hour of usage until the drive reaches the failure threshold temperature and fails. If the current S.M.A.R.T. attributes of a storage device or the trends of such attributes indicate an impending failure of the storage device, the scan handler 318 may generate a failure notification to be provided to the host computing system.

Lifespan estimator 320 may execute on processor 312, and may be configured to determine an estimated lifespan associated with a class of storage devices based on the diagnostic information that has been collected over time for storage devices in the particular class. The particular technique for determining the estimated lifespan may be configurable, e.g., to conform to the particular goals of a given implementation. In some implementations, multiple estimated lifespans may be determined for a particular class of device, e.g., based on how the device is maintained. The estimated lifespans for various classifications of storage devices may be stored in a repository (not shown).

FIG. 4 shows a flow diagram of an example process 400 for predicting the failure of a storage device in accordance with an implementation described herein. The process 400 may be performed, for example, by a computing system, such as analysis computing system 104 illustrated in FIG. 1. For clarity of presentation, the description that follows uses the analysis computing system 104 as the basis of an example for describing the process. However, it should be understood that another system, or combination of systems, may be used to perform the process or various portions of the process.

Process 400 begins at block 410, in which the analysis computing system receives current diagnostic information associated with a storage device. The current diagnostic information may identify the particular storage device (e.g., by a unique device identifier) and may include one or more S.M.A.R.T. attributes associated with the storage device. The current diagnostic information may also include system information associated with the host computing system, such as system configuration information, system events, and/or other appropriate information.

At block 420, the analysis computing system stores the current diagnostic information in a collection that includes historical diagnostic information associated with other storage devices. Upon storage in the collection, the current diagnostic information may be used as historical diagnostic information for subsequent requests provided to the analysis computing system.

At block 430, the analysis computing system predicts whether the storage device (identified in the current diagnostic information) is likely to fail in a given time period based on the current diagnostic information and an estimated lifespan for storage devices of a same classification, where the estimated lifespan is determined based on the collection of historical diagnostic information. In response to predicting that the storage device is likely to fail in the given time period, the analysis computing system may cause a notification to be displayed on the host computing system indicating that the storage device is likely to fail within the given time period.

In some implementations, the current diagnostic information includes a power-on hours attribute, and predicting whether the storage device is likely to fail in the given time period includes comparing the power-on hours attribute to the estimated lifespan. If the difference between the power-on hours attribute and the estimated lifespan is less than the given time period, then the storage device is likely to fail in the given time period. In some implementations, the diagnostic information may also include maintenance information, and predicting whether the storage device is likely to fail in the given time period includes comparing the power-on hours attribute to the estimated lifespan for storage devices that are of a same classification and that are maintained in a similar manner as the storage device.

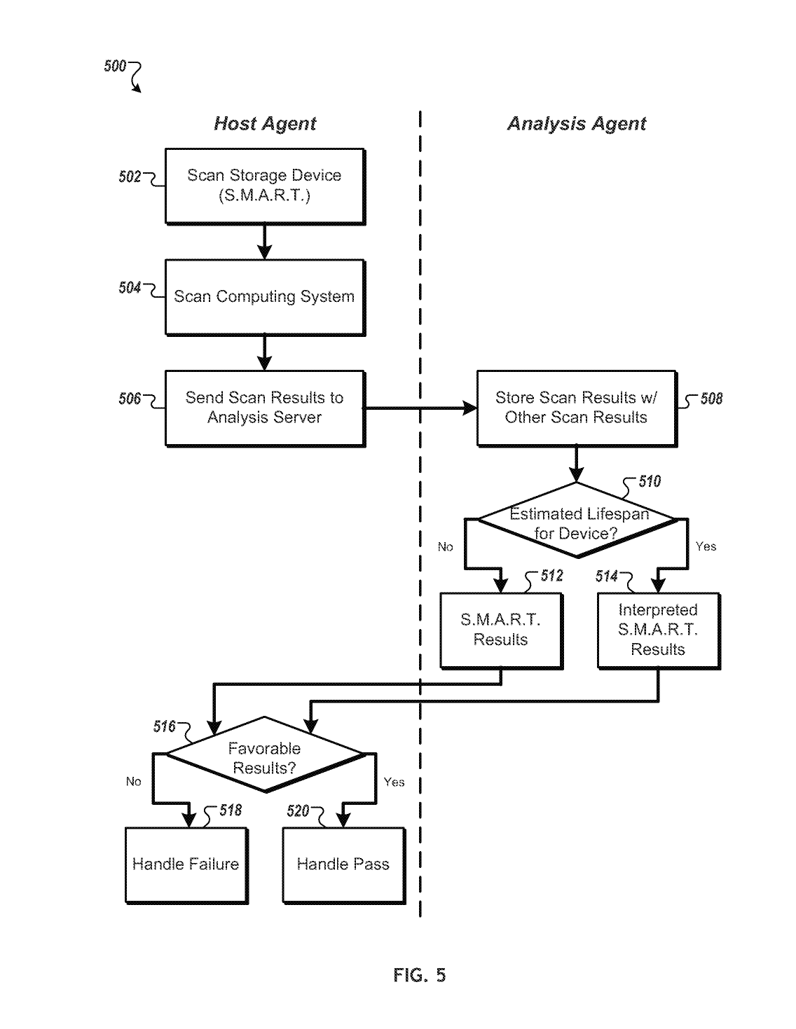

FIG. 5 shows a swim-lane diagram of an example process 500 for collecting and interpreting scan results in accordance with an implementation described herein. The process 500 may be performed, for example, by any of the host computing systems, e.g., 102A, and the analysis computing system 104 illustrated in FIG. 1. For clarity of presentation, the description that follows uses systems 102A and 104 as the basis of an example for describing the process. However, it should be understood that another system, or combination of systems, may be used to perform the process or various portions of the process.

Process 500 begins at block 502, when a host agent, e.g., host agent 112A, initiates a scan of a storage device, e.g., storage device 122A, to collect diagnostic information associated with the storage device. The diagnostic information may include device reliability and/or failure information, including S.M.A.R.T. scan results and/or attributes. At block 504, the host agent initiates a scan of the host computing system to collect diagnostic information associated with the host computing system. Examples of diagnostic information collected from the host computing system may include system configuration information (e.g., operating environment, system identification information, or the like), system events (e.g., disk failures, maintenance events, data restore requests, or the like), and/or other appropriate information. In some implementations, the host agent may initiate the scans of the storage device and/or the computing system on a periodic basis, on a scheduled basis, or on an ad hoc basis. At block 506, the host agent may send the scan results to an analysis agent, e.g., analysis agent 134.

At block 508, the analysis agent 134 stores the scan results along with other scan results that have been received over time from various host computing systems. Over time, the scan results collected from different host computing systems may provide a large population of data from which a relatively accurate lifespan prediction model and/or failure prediction model may be generated. At block 510, the analysis agent 134 determines whether an estimated lifespan has been determined for the device. For example, after the collection includes sufficient information about a particular class of storage device, the analysis agent 134 may determine an estimated lifespan for the particular class of storage device, e.g., based upon all or certain portions of the diagnostic information associated with the various storage devices in the class.

If such an estimated lifespan has not yet been determined for the device, then the analysis agent may simply return the S.M.A.R.T. results back to the host agent at block 512. If an estimated lifespan has been determined for the device, then the analysis agent may interpret the S.M.A.R.T. results, e.g., by predicting whether the storage device is likely to fail based on the device's hours of usage and estimated lifespan. The analysis agent may also analyze other current S.M.A.R.T. attributes to determine whether the attributes, or trends in the attributes, indicate an impending failure, and such information may be included in the interpreted S.M.A.R.T. results. Then, the interpreted S.M.A.R.T. results may be provided back to the host agent at block 514.

At block 516, the host agent determines whether the results returned from the analysis agent are favorable. If the results of the analysis are unfavorable, then the host agent handles the failure results at block 518. For example, the host agent may display a notification to the user indicating that the storage device is likely to fail in the next thirty hours. The host agent may also provide various options to the user to protect the data stored on the storage device before the device fails. If the results of the analysis are favorable, then the host agent handles the passing results at block 520. For example, the host agent may schedule the next scan based on information in the interpreted results, or may simply exit the process.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method for predicting failure of a storage device, the method comprising:
receiving, at an analysis system and from a computing system having a storage device, current diagnostic information associated with the storage device;
storing, using the analysis system, the current diagnostic information in a collection that includes historical diagnostic information associated with other storage devices of other computing systems; and
predicting, using the analysis system, whether the storage device is likely to fail in a given time period based on the current diagnostic information and an estimated lifespan for storage devices that are of a same classification as the storage device, the estimated lifespan determined based on the collection.

2. The method of claim 1, wherein the current diagnostic information includes a power-on hours attribute, and wherein predicting whether the storage device is likely to fail in the given time period comprises comparing the power-on hours attribute to the estimated lifespan, and determining that the storage device is likely to fail in the given time period when the difference between the power-on hours attribute and the estimated lifespan is less than the given time period.

3. The method of claim 2, wherein the current diagnostic information further includes maintenance information associated with the storage device, and the historical diagnostic information includes historical maintenance information associated with the other storage devices, and wherein predicting whether the storage device is likely to fail in the given time period comprises comparing the power-on hours attribute to the estimated lifespan for storage devices that are of a same classification and that are maintained in a similar manner as the storage device, and determining that the storage device is likely to fail within the given time period when the difference between the power-on hours attribute and the estimated lifespan is less than the given time period.

4. The method of claim 1, further comprising causing a notification to be displayed on the computing system in response to predicting that the storage device is likely to fail within the given time period, the notification indicating that the storage device is likely to fail within the given time period.

5. The method of claim 1 wherein the current diagnostic information includes Self-Monitoring, Analysis and Reporting Technology (S.M.A.R.T.) attributes.

6. The method of claim 1, wherein the historical diagnostic information includes actual lifespans for storage devices that have failed.

7. The method of claim 6, wherein device failure events are identified based on restore requests, operating system events, or combinations of restore requests and operating system events.

8. The method of claim 1, wherein, in response to predicting that the storage device is likely to fail in the given time period, a backup provider that has backup data associated with the storage device prepares the backup data for restoration.

9. The method of claim 1, wherein storage devices are considered to be of the same classification when a make and model of the storage devices match and when configuration information of the computing systems in which the storage devices are used matches.

10. A non-transitory computer-readable storage medium storing instructions that, when executed by one or more processors, cause the one or more processors to:
receive, from a host computing system having a storage device, reliability attributes associated with the storage device, the reliability attributes including a power-on hours attribute;
compare the power-on hours attribute of the storage device to an estimated lifespan associated with a population of storage devices that are of a same classification as the storage device, the estimated lifespan determined based on received reliability attributes and device failure information associated with the population of storage devices; and
generate a failure notification if the power-on hours attribute of the storage device exceeds or is approaching the estimated lifespan.

11. The computer-readable storage medium of claim 10, wherein the reliability attributes comprise Self-Monitoring, Analysis and Reporting Technology (S.M.A.R.T.) attributes.

12. The computer-readable storage medium of claim 10, wherein a classification of the storage device comprises make and model of the storage device.

13. The computer-readable storage medium of claim 12, wherein the classification of the storage device further comprises configuration information of the computing system in which the storage device is used.

14. The computer-readable storage medium of claim 10, wherein the failure notification includes an offer from a backup provider for a backup solution,

15. A system for predicting failure of a storage device, the system comprising:
a plurality of host computing systems, each of the plurality of host computing systems having a storage device and a host agent that determines reliability information and failure information associated with the storage device; and
an analysis computing system, communicatively coupled to the plurality of host computing systems, that receives the reliability information and failure information from the respective host agents of the plurality of host computing systems, and determines an estimated lifespan for a particular classification of storage device based on the reliability information and the failure information associated with storage devices of the particular classification, and
wherein, in response to receiving current reliability information associated with a specific storage device of a specific host computing system from among the plurality of host computing systems, the specific storage device being of the particular classification, the analysis computing system determines whether the specific storage device has exceeded or is approaching the estimated lifespan.
